(19) United States
(12) Patent Application Publication
(10) Pub. No.: US 2015/0188106 A1
(43) Pub. Date: Jul. 2, 2015

(54) BATTERY, BATTERY PACK, ELECTRONIC DEVICE, ELECTRIC VEHICLE, ELECTRIC STORAGE DEVICE, AND ELECTRIC POWER SYSTEM

(71) Applicant: Sony Corporation, Tokyo (JP)

(72) Inventors: Kazumasa TAKESHI, Kanagawa (JP); Kazuaki FUKUSHIMA, Kanagawa (JP); Tadahiko KUBOTA, Kanagawa (JP)

(21) Appl. No.: 14/568,767

(22) Filed: Dec. 12, 2014

(30) Foreign Application Priority Data
Dec. 27, 2013 (JP) 2013-273496

(51) Int. Cl. H01M 2/16; B60L 11/18; H01M 4/62; H01M 10/0568; H01M 4/38; H01M 10/052

(52) U.S. Cl. CPC H01M 2/1646; H01M 4/382; H01M 10/052; H01M 4/625; H01M 4/622; H01M 4/38; H01M 10/0568; H01M 2/1613; B60L 11/1879; H01M 2300/0025; H01M 2220/20; H01M 2220/10

(57) ABSTRACT

Provided is a battery which can improve the positive electrode utilization and rate characteristics of a charge-discharge reaction. The battery includes a positive electrode containing sulfur, a negative electrode containing lithium, an electrolyte, and a conductive interlayer provided between the positive electrode and the negative electrode. The conductive interlayer includes a conductive fiber-containing layer, a conductive nanotube-containing layer, or a conductive mesh.

### CROSS REFERENCES TO RELATED APPLICATIONS

The present application claims priority to Japanese Priority Patent Application JP 2013-273496 filed in the Japan Patent Office on Dec. 27, 2013, the entire content of which is hereby incorporated by reference.

### BACKGROUND

The present application relates to a battery, and to a battery pack, an electronic device, an electric vehicle, an electric storage device, and an electric power system which include the battery. More particularly, the technology relates to a battery including a positive electrode containing sulfur.

Common lithium sulfur batteries can provide performance with a positive electrode utilization of approximately 70% (approximately 1200 mAh/g-sulfur) in a low rate region on the order of 0.05 C. However, when the rate is 0.2 C or more, an extreme drop in capacity is observed, and the positive electrode utilization is approximately 50% (approximately 1000 mAh/g-sulfur) or less. This is caused by low conductivity of sulfur as an active material or lithium sulfide produced by the discharge reaction.

Thus, in order to improve the positive electrode utilization and the rate characteristics, techniques for changing the material of a conducting aid or a binder in a positive electrode have been proposed (see for example, Non-Patent Documents 1 and 2). However, most of the techniques allow charge and discharge at high rates by excessively putting a conducting aid, and thus result in a sulfur content of 50 mass % or less in the positive electrode, thereby leasing to a drop in charge/discharge capacity.

As a technique for improving the positive electrode utilization and rate characteristics without reducing the sulfur content in the positive electrode, the insertion of electrolyte-permeable microporous carbon paper (MCP) between a separator and a positive electrode has been also proposed (Non-Patent Document 3).

### CITATION LIST

### Non Patent Literature

[NPL 1] Sheng S. Zhang, Liquid electrolyte lithium/sulfur battery: Fundamental chemistry, problems, and solutions, Journal of Power Sources, 231(2013), 153-162

[NPL 2] Guo-Chun Li, Guo-Ran Li, Shi-Hai Ye, and Xue-Ping Gao, A Polyaniline-Coated Sulfur/Carbon Composite with an Enhanced High-Rate Capability as a Cathode Material for Lithium/Sulfur Batteries, Adv. Energy Mater. 2012, 2, 1238-1245

[NPL 3] Yu-Sheng Su & Arumugam Manthiram, Lithium-sulphur batteries with a microporouscarbon paper as a bifunctional interlayer, NATURE COMMUNICATIONS, DOI: 10.1038/ncomms2163

### SUMMARY

### Technical Problem

Therefore, it is desirable to provide a battery which can improve the positive electrode utilization and rate characteristics of a charge-discharge reaction, and a battery pack, an electronic device, an electric vehicle, an electric storage device, and an electric power system which include the battery.

### Solution to Problem

According to an embodiment of the present application, there is provided a battery including:
a positive electrode containing sulfur;
a negative electrode containing lithium;
an electrolyte; and
a conductive interlayer provided between the positive electrode and the negative electrode,
where the conductive interlayer includes a conductive fiber-containing layer, a conductive nanotube-containing layer, or a conductive mesh.

According to an embodiment of the present application, there is provided a battery pack provided with a battery including:
a positive electrode containing sulfur;
a negative electrode containing lithium;
an electrolyte; and
a conductive interlayer provided between the positive electrode and the negative electrode,
where the conductive interlayer includes a conductive fiber-containing layer, a conductive nanotube-containing layer, or a conductive mesh.

According to an embodiment of the present application, there is provided an electronic device provided with a battery including:
a positive electrode containing sulfur;
a negative electrode containing lithium;
an electrolyte; and
a conductive interlayer provided between the positive electrode and the negative electrode,
where the conductive interlayer includes a conductive fiber-containing layer, a conductive nanotube-containing layer, or a conductive mesh, and powered by the battery.

According to an embodiment of the present application, there is provided an electric vehicle including:
a battery;
a conversion device powered by the battery to convert the power to a driving force for the vehicle; and
a controller for conducting information processing for vehicle control on the basis of information regarding the battery,
where the battery includes:
a positive electrode containing sulfur;
a negative electrode containing lithium;
an electrolyte; and
a conductive interlayer provided between the positive electrode and the negative electrode, and
the conductive interlayer includes a conductive fiber-containing layer, a conductive nanotube-containing layer, or a conductive mesh.

In this electric vehicle, the conversion device is typically powered by the secondary battery to rotate the motor and generate a driving force. This motor can utilize regeneration energy. In addition, the control device conducts information processing for vehicle control on the basis of the remaining battery level of the secondary battery, for example. This electric vehicle encompasses, for example, electric cars, electric motorcycle, electric bicycles, and rail vehicles, and besides, hybrid cars.

According to an embodiment of the present application, there is provided an electric storage device provided with a battery including:
a positive electrode containing sulfur;
a negative electrode containing lithium;
an electrolyte; and
a conductive interlayer provided between the positive electrode and the negative electrode,
where the conductive interlayer includes a conductive fiber-containing layer, a conductive nanotube-containing layer, or a conductive mesh, to supply electric power to an electronic device connected to the battery.

This electric storage device can be, regardless of the intended use thereof, basically used for any electric power system or electric power device, and for example, used for a smart grid.

According to an embodiment of the present application, there is provided an electric power system provided with a battery including:
a positive electrode containing sulfur;
a negative electrode containing lithium;
an electrolyte; and
a conductive interlayer provided between the positive electrode and the negative electrode,
where the conductive interlayer includes a conductive fiber-containing layer, a conductive nanotube-containing layer, or a conductive mesh, and
the system is powered by the battery, or electric power is supplied from an electric generator or a power network to the battery.

This electric power system may be any system as long as the system generally uses electric power, and encompasses simple electric power devices. This electric power system encompasses, for example, smart grids, home energy management systems (HEMS), and vehicles, and is also capable of electric storage.

According to an embodiment of the present application, the conductive interlayer includes a conductive fiber-containing layer, a conductive nanotube-containing layer, or a conductive mesh, and the conductive interlayer can thus trap sulfur or lithium sulfide dissolved in the electrolyte, and give and receive electrons to and from the trapped sulfur or lithium sulfide. Therefore, the sulfur or lithium sulfide dissolved in the electrolyte can be also as a positive electrode material in the conductive interlayer. Furthermore, the conductive fiber-containing layer, conductive nanotube-containing layer, or conductive mesh has a space for receiving deposited lithium sulfide made insoluble in the electrolyte and expanded in volume through the discharge reaction.

### Advantageous Effects of Invention

As described above, according to an embodiment of the present application, the positive electrode utilization and rate characteristics of the charge-discharge reaction can be improved.

Additional features and advantages are described herein, and will be apparent from the following Detailed Description and the figures.

### BRIEF DESCRIPTION OF THE FIGURES

FIG. 1 is a cross-sectional view illustrating a configuration example of a secondary battery according to a first embodiment of the present application;

FIG. 2 is a cross-sectional view representing an enlarged portion of the rolled electrode body shown in FIG. 1;

FIG. 3 is an exploded perspective view illustrating a configuration example of a secondary battery according to a second embodiment of the present application;

FIG. 4 is a cross-sectional view representing an enlarged portion of the rolled electrode body shown in FIG. 3;

FIG. 5 is a block diagram illustrating a configuration example of an electronic pack and an electronic device according to a third embodiment of the present application;

FIG. 6 is a schematic diagram illustrating a configuration example of a power storage system according to a fourth embodiment of the present application;

FIG. 7 is a schematic diagram illustrating a configuration of an electric vehicle according to a fifth embodiment of the present application;

FIG. 8 is a diagram showing charge-discharge characteristics of a lithium sulfur battery according to Example 1;

FIG. 9 is a diagram showing cycle characteristics of the lithium sulfur battery according to Example 1;

FIG. 10 is a diagram showing charge-discharge characteristics of a lithium sulfur battery according to Comparative Example 1;

FIG. 11 is a diagram showing cycle characteristics of the lithium sulfur battery according to Comparative Example 1;

FIG. 12 is a diagram showing an impedance spectrum of the lithium sulfur battery according to Example 1;

FIG. 13 is a diagram showing an impedance spectrum of the lithium sulfur battery according to Comparative Example 1;

FIG. 14 shows cycle characteristics of the lithium sulfur batteries according to Examples 3 to 6;

FIG. 15 shows rate characteristics of the lithium sulfur batteries according to Examples 1, 2, and 6 and Comparative Examples 1 to 4; and

FIG. 16 shows rate characteristics of the lithium sulfur batteries according to Examples 3 to 5 and Comparative Examples 1 to 4.

### DETAILED DESCRIPTION

The inventors have carried out earnest studies in order to improve the positive electrode utilization and rate characteristics of a charge-discharge reaction. The dissolution, in the electrolyte, of Li₂Sₓ (x=4 to 8) produced during the discharge reaction makes it difficult to give and receive electrons in the positive electrode reaction. The Li₂Sₓ (x=1 to 2) produced at a late stage of discharge is insoluble in the electrolyte and is a non-conductor, thus serving as a resistance component. Because the Li₂Sₓ causes a volume expansion as the value of x is smaller, whether or not there is a space for making the expansion of the Li₂Sₓ possible is also an important factor for the improvement of the characteristics.

However, the technique described in Non Patent Literature 3 mentioned above fails to ensure the space for enabling the volume expansion of the Li₂Sₓ, because microporous carbon paper is inserted between the separator and the positive electrode. For this reason, the improvement in positive electrode utilization and rate characteristics is believed to be insufficient.

Thus, the inventors have considered that the positive electrode utilization and rate characteristics will be improved if a reaction field is provided where electron transfer from or to the positive electrode and the volume expansion are possible even when the sulfur component is dissolved to migrate in the electrolyte, and carried out earnest studies on such a battery. As a result, a battery has been found which has, between a positive electrode and a separator, a conductive fiber-containing layer, a conductive nanotube-containing layer, or a conductive mesh provided as a conductive interlayer.

Embodiments according to the present application will be described in the following order.
1. First Embodiment (Example of Cylindrical Battery)
2. Second Embodiment (Example of Flattened Battery)
3. Third Embodiment (Example of Battery Pack and Electronic Device)
4. Fourth Embodiment (Example of Power Storage System)
5. Fifth Embodiment (Example of Electric Vehicle)

### 1. First Embodiment

[Configuration of Battery]

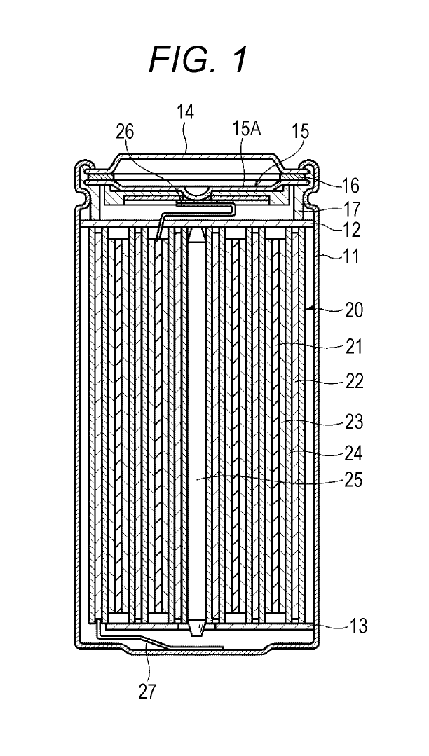

FIG. 1 is a cross-sectional view illustrating a configuration example of a secondary battery according to a first embodiment of the present application. This secondary battery is a non-aqueous electrolyte secondary battery, more preferably, a lithium sulfur battery. This secondary battery is a so-called cylindrical battery, which has a rolled electrode body 20 of a pair of strip positive electrode 21 and strip negative electrode 22 stacked and rolled with a conductive interlayer 23 and a separator 24 interposed therebetween inside a nearly hollow columnar battery can 11. It is to be noted that the conductive interlayer 23 is provided adjacent to the positive electrode 21, whereas the separator 24 is provided adjacent to the negative electrode 22. The battery can 11 is formed from iron (Fe) plated with nickel (Ni), with an end closed and the other end opened. The battery can 11 has an electrolytic solution injected therein, which impregnate the conductive interlayer 23 and the separator 24. Furthermore, a pair of insulating plates 12, 13 is placed each perpendicular to the roll peripheral surfaces so as to sandwich the rolled electrode body 20.

The open end of the battery can 11 has a battery lid 14, a safety valve mechanism 15 provided inside the battery lid 14, and a heat sensitive resistor element (Positive Temperature Coefficient; PTC element) 16, which are attached by swaging with a sealing gasket 17 interposed therebetween. Thus, the inside of the battery can 11 is hermetically sealed. The battery lid 14 is formed from, for example, the same material as the battery can 11. The safety valve mechanism 15 is electrically connected to the battery lid 14 so that a disk plate 15A is reversed to terminate the electrical connection between the battery lid 14 and the rolled electrode body 20 when the internal pressure in the battery reaches a certain level or more because of internal short circuit, external heating, or the like. The sealing gasket 17 is formed from, for example, an insulating material, and asphalt is applied to the surface thereof.

For example, a center pin 25 is inserted in the center of the rolled electrode body 20. A positive electrode lead 26 of aluminum (Al) or the like is connected to the positive electrode 21 of the rolled electrode body 20, whereas a negative electrode lead 27 of Ni or the like is connected to the negative electrode 22 thereof. The positive electrode lead 26 is welded to the safety valve mechanism 15, and thereby electrically connected to the battery lid 14, whereas the negative electrode lead 27 is welded to, and thereby electrically connected to the battery can 11.

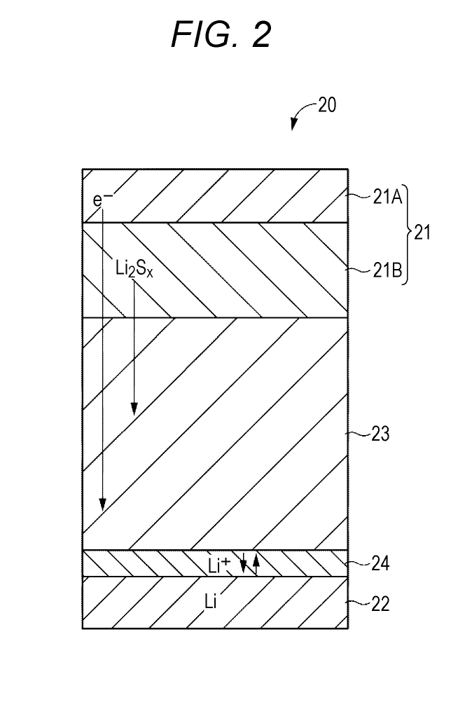

FIG. 2 is a cross-sectional view representing an enlarged portion of the rolled electrode body 20 shown in FIG. 1. The positive electrode 21, negative electrode 22, conductive interlayer 23, separator 24, and electrolytic solution which constitute the secondary battery will be described below with reference to FIG. 2.

(Positive Electrode)

The positive electrode 21 is structured to have, for example, a positive electrode active material layer 21B provided on both sides of a positive electrode collector 21A. It is to be noted that the positive electrode active material layer 21B may be provided on only one side of the positive electrode collector 21A. The positive electrode collector 21A is formed from, for example, metal foil such as aluminum foil. The positive electrode active material layer 21B contains, for example, sulfur as a positive electrode active material, and if necessary, includes a conducting aid and a binder.

As the conducting aid, it is also possible to use either aids which trap sulfur or lithium sulfide dissolved in the electrolytic solution in the positive electrode active material layer 21B, or aids which trap substantially no sulfur or lithium sulfide, while it is preferable to use aids which trap substantially no sulfur or lithium sulfide. This is because the sulfur or lithium sulfide dissolved in the electrolytic solution in the positive electrode active material layer 21B can migrate to the conductive interlayer 23 without being substantially trapped by the conducting aid, thus making the positive electrode reaction to proceed, and making it possible to further improve the positive electrode utilization (discharge capacity).

As the conducting aids which trap sulfur or lithium sulfide, porous conducting aids can be used, such as, for example, microporous (average pore diameter: less than 2 nm) or mesoporous (average pore diameter: 2 nm or more and 50 nm or less). The porous conducting aids may be any aid as long as the aid can provide the positive electrode active material layer 21B with favorable conductivity and has pores at the surface, but are not to be considered particularly limited. To give examples, carbon materials such as carbon black and metal materials can be used. As the carbon black, acetylene black, Ketjen Black, and the like can be used, for example.

As the conducting aids which trap substantially no sulfur or lithium sulfide, for example, non-porous conducting aids can be used which have no pores at the surfaces, or have substantially no pores at the surfaces. The non-porous materials may be any material as long as the material can provide the positive electrode active material layer 21B with favorable conductivity, and has no pores at the surface or substantially no pores at the surface, but are not to be considered particularly limited. To give examples, the materials include carbon materials such as carbon fibers, carbon black, and carbon nanotubes, and one of the materials can be used, or two or more thereof can be mixed and used. As the carbon fibers, for example, vapor-grown carbon fibers (Vapor Growth Carbon Fiber: VGCF) and the like can be used. As the carbon nanotubes, single-walled carbon nanotubes (SWCNT) and multiwall carbon nanotubes (MWCNT) such as double-walled carbon nanotubes (DWCNT) can be used, for example. In addition, materials other than the carbon materials can be also used as long as the materials have favorable conductivity, and for example, metal materials such as Ni powders or conductive polymer materials may be used.

As the binder, polymer resins can be used, such as, for example, fluorine-containing resins, e.g., polyvinylidene fluoride (PVdF) and polytetrafluoroethylene (PTFE), polyvinyl alcohol (PVA) resins, and styrene-butadiene copolymer rubbers (SBR) resins. In addition, conductive polymers may be used as the binder. As the conductive polymers, substituted or unsubstituted polyaniline, polypyrrole, and polythiophene, and (co)polymers of one or two selected therefrom can be used, for example.

(Negative Electrode)

The negative electrode 22 includes, as a negative electrode active material, any one of, or two or more of negative electrode materials which are able to store and release lithium. The negative electrode 22 may include a binder as in the case of the positive electrode active material layer 21B, if necessary.

As the materials for storing and releasing lithium ions, metal lithium and lithium alloys can be used, for example. The lithium alloys include, for example, alloys of lithium with aluminum, silicon, tin, magnesium, indium, calcium, or the like.

(Conductive Interlayer)

The conductive interlayer 23 can hold the electrolytic solution, achieve lithium ion permeation, and give and receive electrons necessary for the protective electrode reaction to and from sulfur as a positive electrode active material dissolved in the electrolytic solution or lithium sulfide produced by the discharge reaction. Furthermore, the conductive interlayer 23 has a space for receiving deposited lithium sulfide made insoluble in the electrolytic solution and expanded in volume through the discharge reaction.

The conductive interlayer 23 includes a conductive fiber-containing layer, a conductive nanotube-containing layer, or a conductive mesh. The conductive interlayer 23 may include a stacked body of two or more conductive interlayers stacked. The conductive interlayer 23 has a large number of voids, and the voids serve as spaces for receiving the volume expansion of lithium sulfide eluted in the electrolytic solution.

The conductive fiber-containing layer includes, for example, a conductive non-woven fabric or a conductive woven fabric. The conductive fiber-containing layer may include a fiber sintered body. The conductive non-woven fabric is, for example, a sheet-like fabric of conductive fibers entangled without being woven. The conductive woven fabric is, for example, a sheet-like fabric of conductive fibers woven. In this specification, a composition of woven conductive fibers of less than 10 μm in average fiber diameter is defined as the conductive woven fabric. Furthermore, a composition of woven conductive wires of 10 μm or more in average wire diameter is defined as a conductive mesh.

The conductive fibers constituting the non-woven fabric and the woven fabric contain at least one selected from the group consisting of, for example, carbon, metals, and conductive polymers. More specifically, the conductive fibers contain at least one selected from the group consisting of carbon fibers, metal fibers, conductive polymer fibers, and conductive material coated fibers.

As the carbon fibers, at least one of polyacrylonitrile (PAN) based carbon fibers and pitch-based carbon fibers can be used, for example. Specific examples of the non-woven fabric and woven fabric containing the carbon fibers include, for example, carbon paper, carbon cloth, and carbon felt. In addition, carbon dispersed in fibers such as organic fibers or glass fibers can be also used as the carbon fibers.

As the metal fibers, fibers containing metals as their main constituents or metals dispersed in fibers such as organic fibers or glass fibers can be used, for example. The metals can include, for example, simple elements such as Ti, W, Mo, Ta, Nb, Zr, Zn, Ni, Cr, Fe, Ag, Al, and Au, and alloys containing two or more of these elements. As the alloys, it is preferable to use stainless steel (Stainless Used Steel: SUS), nickel alloys such as NiCu alloys and NiCr alloys, etc.

The conductive material coated fibers are configured to have fibers as a core material with a conductive material. Specific examples of the fibers can include carbon coated fibers, metal coated fibers, and conductive polymer coated fibers. As the fibers as a core material, insulating fibers can be used such as, for example, organic fibers and glass fibers, without limitation to the insulating fibers, but conductive fibers such as carbon fibers, metal fibers, and conductive polymer fibers may be used as the core material.

As the conductive nanotube contained in the conductive nanotube-containing layer, carbon nanotubes (CNT) and metal nanotubes can be used, for example. As the CNT, single-walled carbon nanotubes (SWCNT) and multiwall carbon nanotubes (MWCNT) such as double-walled carbon nanotubes (DWCNT) can be used, for example. The conductive nanotube-containing layer may contain a binder, etc., if necessary. Examples of the binder can include the same binder as used in the positive electrode active material layer 21B. As the conductive nanotube-containing layer, oriented or non-oriented conductive nanotube-containing layers can be used, for example. The orientation direction of the conductive nanotube is, for example, the thickness of the conductive nanotube-containing layer, that is, a direction perpendicular to the principal surface of the positive electrode 21. The metal nanotubes contain, as their main constituents, for example, a simple element such as Ti, W, Mo, Ta, Nb, Zr, Zn, Ni, Cr, Fe, Ag, Al, and Au, and an alloy containing two or more of these elements.

The conductive mesh is, for example, a metal mesh containing a metal. Examples of the metal can include, for example, simple elements such as Ti, W, Mo, Ta, Nb, Zr, Zn, Ni, Cr, Fe, Ag, Al, and Au, and alloys containing two or more of these elements. As the alloys, it is preferable to use stainless steel, nickel alloys such as NiCu alloys and NiCr alloys, etc. As the stainless steel, it is preferable to use SUS304, SUS304L, SUS310S, SUS316, SUS316L, SUS317L, SUS321, SUS347, and the like. Examples of the weave for the conductive mesh include, but not particularly limited to, plain weave, twill weave, plain dutch weave, twilled dutch weave, for example. The surface of the conductive mesh may be provided with a CNT layer formed from a CNT. This CNT layer is formed by, for example, chemical vapor deposition (CVD).

(Separator)

The separator 24 is intended to separate the positive electrode 21 and the negative electrode 22 from each other, and allow lithium ions to pass therethrough while preventing short circuit from being caused by an electric current due to the both electrodes in contact with each other. As the separator 24, porous films made from synthetic resins such as polytetrafluoroethylene, polypropylene, or polyethylene, or ceramic porous films as single layers, or the multiple porous films stacked can be used, for example. In particular, porous films made from polyolefin are preferred as the separator 24. This is because the films have the excellent effect of short circuit prevention, and can make an improvement in battery safety due to the effect of shutdown. In addition, porous resin layers such as polyvinylidene fluoride (PVdF) or polytetrafluoroethylene (PTFE) formed on microporous films such as polyolefin may be used as the separator 24.

(Electrolytic Solution)

The conductive interlayer 23 and the separator 24 are impregnated with an electrolytic solution that is a liquid electrolyte. This electrolytic solution contains an organic solvent and an electrolyte salt dissolved in the organic solvent.

As the organic solvent, carbonates such as ethylene carbonate (EC), propylene carbonate (PC), diethyl carbonate (DEC), dimethyl carbonate (DMC), methylethyl carbonate (MEC), and vinylene carbonate (VC); cyclic esters such as γ-butyrolactone (GBL), γ-valerolactone, 3-methyl-γ-butyrolactone, and 2-methyl-γ-butyrolactone; cyclic ethers such as 1,4-dioxane, 1,3-dioxolan (DOL), tetrahydrofurane, 2-methyltetrahydrofuran (MTHF), 3-methyl-1,3-dioxolan, and 2-methyl-1,3-dioxolan; and chain ethers such as 1,2-dimethoxyethane (DME), 1,2-diethoxyethane (DEE), diethyl ether, dimethyl ether, methylethyl ether, dipropyl ether, bis[2-(2-methoxyethyoxy)ethyl]ether(tetraglyme), and 1,1,2,2-tetrafluoroethyl-2,2,3,3-tetrafluoropropylether can be used. As the organic solvent, for example, methyl propionate (MPR), ethyl propionate (EPR), ethylene sulfite (ES), cyclohexylbenzene (CHB), tetraphenylbenzene (tPB), ethyl acetate (EA), and acetonitrile (AN) can be also used besides the solvents mentioned above. Two or more of the organic solvents mentioned above may be mixed and used as mixed solvents.

Examples of the electrolyte salt include, for example, lithium salts, and one of the lithium salt may be used singly, or two or more thereof may be used in mixture. The lithium salts include, for example, LiSCN, LiBr, LiI, LiClO₄, LiASF₆, LiSO₃CF₃, LiSO₃CH₃, LiBF₄, LiB(Ph)₄, LiPF₆, LiC(SO₂CF₃)₃, and LiN(SO₂CF₃)₂(LiTFSI).

Various types of materials other than the materials mentioned above can be added to the electrolyte, if necessary, in order to improve various characteristics of the lithium sulfur battery. These materials can include, for example, imide salts, sulfonated compounds, aromatic compounds, and halogen substituted products thereof.

While both kasolite and non-kasolite electrolytic solutions can be used as the electrolytic solution, it is preferable to use a kasolite electrolytic solution. The use of the kasolite electrolytic solution can form a new positive electrode surface with the charge-discharge reaction, because the sulfur of the positive electrode 21 can be eluted in a positive manner. Therefore, LiS as a non-conductor produced and deposited at the positive electrode-electrolytic solution interface can suppress the inhibition of reaction between fresh sulfur and lithium cations, and thus further improve the positive electrode utilization (discharge capacity). As the kasolite electrolytic solution, for example, an electrolytic solution can be used which contains LiTFSI, 1,2-dimethoxyethane (DME), and 1,3-dioxolan (DOL). In this technology, the kasolite electrolytic solution refers to an electrolytic solution with a positive electrode active material dissolved therein. On the other hand, the non-kasolite electrolytic solution refers to an electrolytic solution with no positive electrode active material dissolved therein, or substantially no positive electrode active material dissolved therein.

[Operation of Lithium Sulfur Battery]

In the secondary battery configured as described above, in the case of charge, lithium ions (Li⁺) move from the positive electrode 21 through the electrolytic solution to the negative electrode 22 to convert electrical energy into chemical energy and store electricity. In the case of discharge, lithium ions return from the negative electrode 22 through the electrolytic solution to the positive electrode 21 to generate electrical energy.

[Production Method for Battery]

Next, an example of a method for producing the secondary battery according to the first embodiment of the present application will be described.

First, for example, a positive electrode active material, a conducting aid, and a binder are mixed to prepare a positive electrode combination, and this positive electrode combination is dispersed in a solvent such as N-methyl-2-pyrrolidone (NMP) to prepare positive electrode combination slurry in the form of paste. Next, this positive electrode combination slurry is applied to the positive electrode collector 21A, and subjected to solvent drying, and subjected to compression molding with a roll pressing machine to form the positive electrode active material layer 21B. Thus, the positive electrode 21 is obtained.

Next, the positive electrode lead 26 is attached by welding or the like to the positive electrode collector 21A, and a negative electrode lead 27 is attached by welding or the like to the negative electrode 22. Next, the positive electrode 21 and the negative electrode 22 are rolled with the conductive interlayer 23 and the separator 24 interposed therebetween. In this regard, the conductive interlayer 23 is placed between the positive electrode 21 and the separator 24, and the separator 24 is placed between the conductive interlayer 23 and the negative electrode 22. It is to be noted that the conductive interlayer 23 may be formed in advance on the surface of the positive electrode 21 or separator 24. Next, a head of the positive electrode lead 26 is welded to the safety valve mechanism 15, whereas a head of the negative electrode lead 27 is welded to the battery can 11, and the rolled positive electrode 21 and negative electrode 22 are sandwiched by a pair of insulating plates 12, 13, and housed within the battery can 11. Next, after the positive electrode 21 and the negative electrode 22 are housed within the battery can 11, the electrolytic solution is injected into the battery can 11 to impregnate the separator 24. Next, the battery lid 14, the safety valve mechanism 15, and the heat-sensitive resistive element 16 are fixed to the open end of the battery can 11 by swaging with the gasket 17 interposed. Thus, the secondary battery shown in FIG. 1 is obtained.

[Advantageous Effect]

The secondary battery according to the first embodiment is provided with the conductive interlayer 23 including the conductive fiber-containing layer, conductive nanotube-containing layer, or conductive mesh between the positive electrode 21 and the separator 24. Thus, the sulfur or lithium sulfide dissolved in the electrolytic solution can be trapped by the conductive interlayer 23, and electron transfer can be also achieved between the trapped sulfur or lithium sulfide and the positive electrode 21. Accordingly, even when the sulfur or lithium sulfide is dissolved in the electrolytic solution, the positive electrode reaction can proceed in the conductive fiber-containing layer. Furthermore, the conductive fiber-containing layer, conductive nanotube-containing layer, or conductive mesh has a number of voids (spaces), and thus can receive the volume expansion of lithium sulfide eluted into the electrolytic solution. Accordingly, the positive electrode utilization and rate characteristics of the charge-discharge reaction can be improved.

When a conducting aid that traps substantially no sulfur or lithium sulfide dissolved in the positive electrode active material layer 21B is used as the conducting aid for the positive electrode active material layer 21B, the sulfur or lithium sulfide dissolved in the electrolytic solution in the positive electrode active material layer 21B can migrate to the conductive interlayer 23. Thus, the positive electrode active material layer 21B can have a new surface formed with the charge-discharge reaction. More specifically, LiS as a non-conductor produced and deposited at the positive electrode-electrolytic solution interface can suppress the inhibition of reaction between fresh sulfur and lithium cations, and thus further improve the positive electrode utilization (i.e., discharge capacity).

When the kasolite electrolytic solution is used as the electrolytic solution, the positive electrode active material layer 21B can have a new surface formed with the charge-discharge reaction, because the sulfur of the positive electrode 21 can be eluted into the electrolytic solution in a positive manner. Accordingly, LiS as a non-conductor produced and deposited at the positive electrode-electrolytic solution interface can suppress the inhibition of reaction between fresh sulfur and lithium cations, and thus further improve the positive electrode utilization (i.e., discharge capacity).

### 2. Second Embodiment

[Configuration of Battery]

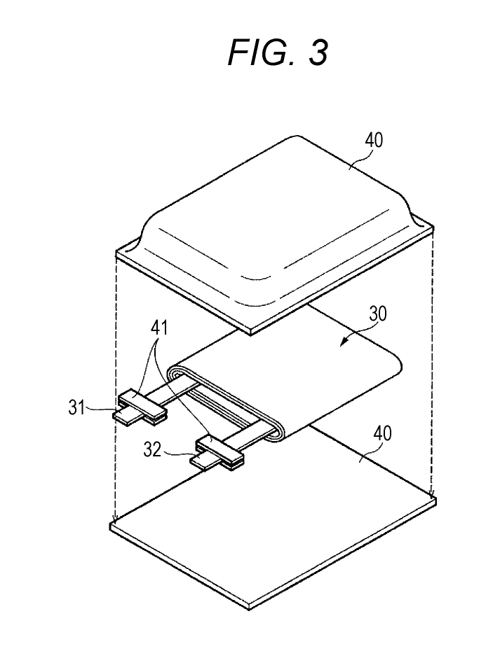

FIG. 3 is an exploded perspective view illustrating a configuration example of a secondary battery according to a second embodiment of the present application. This secondary battery has a rolled electrode body 30 with a positive electrode lead 31 and a negative electrode lead 32 attached thereto, which is housed within a filmy exterior member 40, thus allowing the reduction in size, the reduction in weight, and the reduction in thickness.

The positive electrode lead 31 and the negative electrode lead 32 are each leaded out, for example, in the same direction from the inside of the exterior member 40 toward the outside. The positive electrode lead 31 and the negative electrode lead 32 are each formed from a metal material such as, for example, aluminum, copper, nickel, or stainless steel, and each adapted to the form of a thin plate or a mesh.

The exterior member 40 is formed from, for example, a rectangular aluminum laminate film of a nylon film, aluminum foil, and a polyethylene film laminated in this order. The exterior member 40 is provided, for example, so as to oppose the polyethylene film side to the rolled electrode body 30, and the outer edges are closely attached to each other by fusion or with an adhesive. Adhesive films 41 for preventing ingress of outside air are inserted between the exterior member 40 and the positive electrode lead 31 and negative electrode lead 32. The adhesive film 41 is formed from a material that is adhesive to the positive electrode lead 31 and the negative electrode lead 32, a polyolefin resin such as, for example, polyethylene, polypropylene, modified polyethylene, or modified polypropylene.

It is to be noted that the exterior member 40 may be formed from a laminate film that has other structure, a polymer film such as polypropylene, or a metal film, in place of the aluminum laminate film mentioned above.

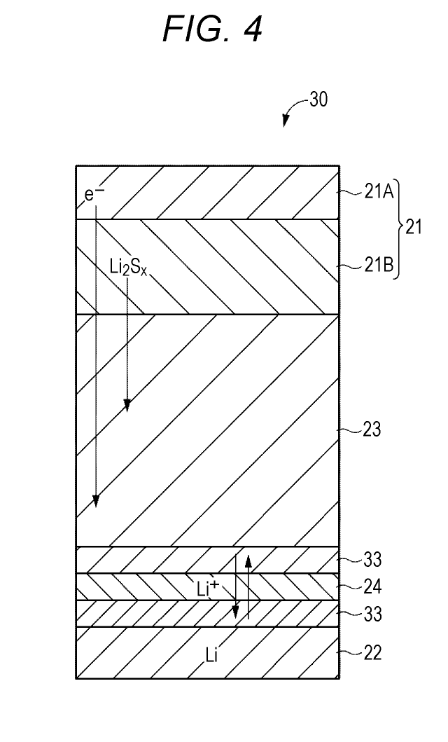

FIG. 4 is a cross-sectional view representing an enlarged portion of the rolled electrode body shown in FIG. 3. The rolled electrode body 30 is obtained in such a way that the positive electrode 21 and the negative electrode 22 are stacked with the conductive interlayer 23, the separator 24, and an electrolyte layer 33 interposed therebetween, and rolled, and the outermost periphery may be protected with a protective tape (not shown). The electrolyte layer 33 is provided between the conductive interlayer 23 and the separator 24, and also provided between the negative electrode 22 and the separator 24. In the second embodiment, the same elements as in the first embodiment are denoted by the same reference numerals, and description of the elements will be omitted.

The electrolyte layer 33 contains an electrolytic solution and a polymer compound which serves as a holder for holding the electrolytic solution, in the form of a so-called gel. The gel-like electrolyte layer 33 is preferred because the layer can achieve a high ionic conductivity, and prevent the battery from liquid leakage. The electrolytic solution has the same composition as in the secondary battery according to the first embodiment. Examples of the polymer compound include, for example, polyacrylonitrile, polyvinylidene fluoride, copolymers of vinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethylmethacrylate, polyacrylic acid, polymethacrylic acid, styrene-butadiene rubbers, nitrile-butadiene rubbers, polystyrene, and polycarbonate. In particular, in terms of electrochemical stability, polyacrylonitrile, polyvinylidene fluoride, polyhexafluoropropylene, or polyethylene oxide is preferred.

[Production Method for Battery]

Next, an example of a method for producing the secondary battery according to the second embodiment of the present application will be described. First, a precursor solution containing a solvent, an electrolyte salt, a polymer compound, and a mixed solvent is applied to each of the negative electrode 22 and conductive interlayer 23, and the mixed solvent is volatilized to form the electrolyte layers 33. Next, the positive electrode lead 31 is attached by welding to an end of the positive electrode collector 21A, and the negative electrode lead 32 is attached by welding to an end of the negative electrode 22. Next, the positive electrode 21 and the negative electrode 22 are stacked with the conductive interlayer 23 and separator 24 interposed therebetween to provide a stacked body, this stacked body is then rolled in the longitudinal direction, and a protective tape is bonded to the outermost periphery of the rolled stacked body to form the rolled electrode body 30. Finally, the rolled electrode body 30 is sandwiched, for example, between the exterior members 40, and outer edges of the exterior members 40 are closely attached to each other by thermal fusion bonding or the like to achieve sealing. In that regard, the adhesive films 41 are inserted between the positive electrode lead 31 and negative electrode lead 32 and the exterior members 40. Thus, the secondary battery shown in FIG. 3 is obtained.

Alternatively, the secondary battery according to the second embodiment of the present application may be prepared in the following way. First, the positive electrode lead 31 and the negative electrode lead 32 are attached to the positive electrode 21 and the negative electrode 22. Next, the positive electrode 21 and the negative electrode 22 are stacked with the conductive interlayer 23 and separator 24 interposed therebetween, and rolled, and a protective tape is bonded to the outermost periphery of the rolled stacked body to form a rolled body as a precursor of the rolled electrode body 30. Next, this rolled body is sandwiched between the exterior members 40, while outer peripheral edges except one side are subjected to thermal fusion bonding into the form of a bag, and housed within the exterior member 40. Next, a composition for the electrolyte, which contains a solvent, an electrolyte solution, a monomer as a raw material for the polymer compound, a polymerization initiator, and if necessary, other materials such as a polymerization inhibitor, is prepared, and injected into the exterior member 40.

Next, after the composition for the electrolyte is injected into the exterior member 40, the opening of the exterior member 40 is hermetically sealed by thermal fusion bonding under a vacuum atmosphere. Next, heat is applied to provide the polymer compound by the polymerization of the monomer, thereby forming gel-like electrolyte layers 33. As just described, the secondary battery shown in FIG. 3 is obtained.

The secondary battery according to the second embodiment has the same operation and advantageous effects as in the case of the secondary battery according to the first embodiment.

### 3. Third Embodiment

In the third embodiment, a battery pack and an electronic device will be described which include the secondary battery according to the first or second embodiment.

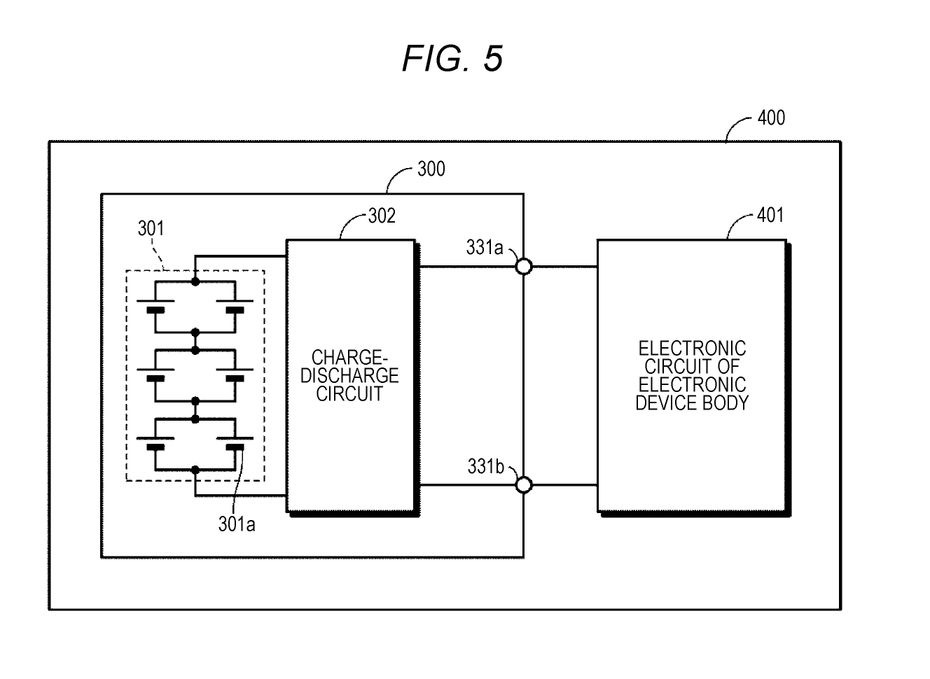

A configuration example of a battery pack 300 and an electronic device 400 according to the third embodiment of the present application will be described below with reference to FIG. 5. The electronic device 400 includes an electronic circuit 401 of an electronic device body, and the battery pack 300. The battery pack 300 is electrically connected to the electronic circuit 401 via a positive electrode terminal 331a and a negative electrode terminal 331b. The electronic device 400 is configured, for example, so that the battery pack 300 is able to be removed by users. It is to be noted that the configuration of the electronic device 400 is not to be considered limited to this configuration, but the battery pack 300 may be built into the electronic device 400 so that users are not able to remove the battery pack 300 from the electronic device 400.

In the case of charging the battery pack 300, the positive electrode terminal 331a and negative electrode terminal 331b of the battery pack 300 are respectively connected to a positive electrode terminal and a negative electrode terminal of a charger (not shown). On the other hand, in the case of discharging the battery pack 300 (in the case of using the electronic device 400), the positive electrode terminal 331a and negative electrode terminal 331b of the battery pack 300 are respectively connected to a positive electrode terminal and a negative electrode terminal of the electronic circuit 401.

Examples of the electronic device 400 include, but not limited to, for example, laptop personal computers, tablet computers, cellular phones (for example, smartphones), personal digital assistants (PDA), imaging devices (for example, digital still cameras, digital video cameras), audio equipment (for example, portable audio players), game machines, cordless phone handsets, electronic books, electronic dictionaries, radios, headphones, navigation systems, memory cards, pacemakers, hearing aids, electrical tools, electrical shavers, refrigerators, air conditioners, televisions, stereos, water heaters, microwaves, dishwashers, washing machines, dryers, lighting equipment, toys, medical devices, robots, road conditioners, and traffic lights.

(Electronic Circuit)

The electronic circuit 401 includes, for example, a CPU, a peripheral logic unit, an interface unit, and a memory unit, and generally controls the electronic device 400.

(Battery Pack)

The battery pack 300 includes an assembled battery 301 and a charge-discharge circuit 302. The assembled battery 301 is configured to have a plurality of secondary batteries 301a connected in series and/or in parallel. The plurality of secondary batteries 301a is connected, for example, in n parallel and in m series (n and m are positive integers). It is to be noted that an example of six secondary batteries 301a connected in 2 parallel and in 3 series (2P3S) is shown in FIG. 5. The secondary battery according to the first or second embodiment is used as the secondary battery 301a.

In the case of charge, the charge-discharge circuit 302 controls the charge for the assembled battery 301. On the other hand, in the case of discharge (that is, in the case of using the electronic device 400), the charge-discharge circuit 302 controls the discharge for the electronic device 400.

### 4. Fourth Embodiment

In the fourth embodiment, an electric storage system will be described which includes, in an electric storage device, the secondary battery according to the first or second embodiment.

[Configuration of Electric Storage System]

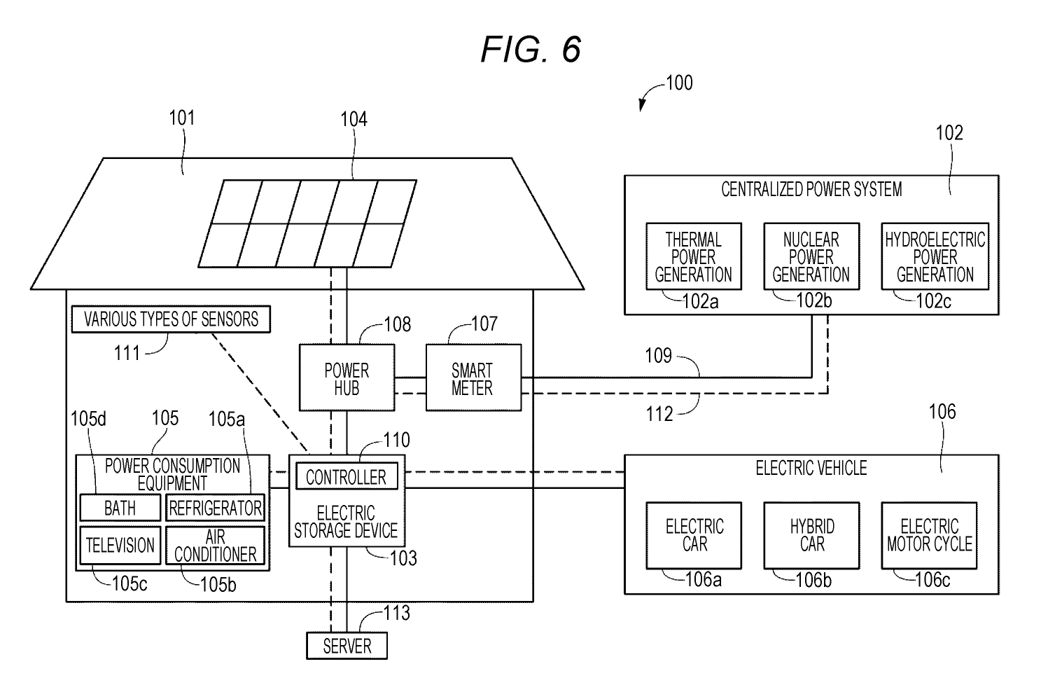

A configuration example of an electric storage system (electric power system) 100 according to the fourth embodiment will be described below with reference to FIG. 6. This electric storage system 100 is a residential electric storage system, where electric power is supplied from a centralized power system 102 such as a thermal power generation 102a, a nuclear power generation 102b, and a hydroelectric power generation 102c, via a power network 109, an information network 112, a smart meter 107, a power hub 108, to an electric storage device 103. Besides, electric power is supplied from an independent power source such as a household electric generator 104 to the electric storage device 103. The electric power supplied to the electric storage device 103 is stored. The electric storage device 103 is used to supply electric power for used in a house 101. The same electric storage system can be used for not only the house 101 but also buildings.

The house 101 is provided with the household electric generator 104, a power consumption equipment 105, the electric storage device 103, a controller 110 for controlling each device, the smart meter 107, the power hub 108, and sensors 111 for acquiring various pieces of information. The respective devices are connected via the power network 109 and the information network 112. As the household electric generator 104, solar cells, fuel cells, and the like are used, and electric power generated is supplied to the power consumption equipment 105 and/or the electric storage device 103. The power consumption equipment 105 includes a refrigerator 105a, an air conditioner 105b, a television receiver 105c, and a bath 105d. Furthermore, the power consumption equipment 105 also includes an electric vehicle 106. The electric vehicle 106 includes an electric car 106a, a hybrid car 106b, and electric motorcycle 106c.

The electric storage device 103 includes the secondary battery according to the first or second embodiment. The smart meter 107 has the function of measuring the commercial power usage, and transmitting the measured usage to a power company. The power network 109 may be any one of direct-current power feeding, alternate-current power feeding, and non-contact power feeding, or a combination of thereof.

The various types of sensors 111 include, for example, human sensitive sensors, illuminance sensors, object detection sensors, power consumption sensors, vibration sensors, contact sensors, temperature sensors, and infrared sensors. The information acquired by the various types of sensors 111 is transmitted to the controller 110. Based on information from the sensors 111, meteorological conditions, human conditions, etc. are grasped to make it possible to automatically control the power consumption equipment 105, thereby minimizing energy consumption. Moreover, the controller 110 can transmit information regarding the house 101 via the Internet to external power companies.

The power hub 108 execute processing such as power line branching and DC/AC conversion. Communication systems for the information network 112 connected to the controller 110 include methods of using communication interfaces such as UART (Universal Asynchronous Receiver-Transceiver), and methods of utilizing sensor networks according to wireless communication standards such as Bluetooth (registered trademark), ZigBee, WiFi. The Bluetooth (registered trademark) system can be applied to multimedia communications to establish one-to-one communications connections. The ZigBee uses a physical layer of IEEE (Institute of Electrical and Electronics Engineers) 802.15.4. The IEEE 802.15.4 is the name of a short-range wireless network standard referred to as PAN (Personal Area Network) or W (Wireless) PAN.

The controller 110 is connected to an external server 113. This server 113 may be managed by any of the house 101, a power company, and a service provider. The information sent and received by the server 113 includes, for example, information on power consumption, information on life patterns, power charges, weather information, information on natural disasters, and information regarding electricity trading. These pieces of information may be sent and received from a household power consumption device (for example, a television receiver), or may sent and received from a device outside the home (for example, a cellular phone). These pieces of information may be displayed on a device that has a display function, for example, a television receiver, a cellular phone, a PDA (Personal Digital Assistants), or the like.

The controller 110 for controlling each unit is configured to have a CPU (Central Processing Unit), a RAM (Random Access Memory), a ROM (Read Only Memory), etc. and in this case, housed in the electric storage device 103. The controller 110 is connected via the information network 112 to the electric storage device 103, the household electric generator 104, the power consumption equipment 105, the various types of sensors 111, and the server 113, and adapted to have, for example, the function of regulating the commercial power usage and power generation capacity. Further, besides, the controller may have the function of electricity trading in the electricity market.

As just described, the electric storage device 103 can store therein power generated from not only the centralized power system 102 such as the thermal power generation 102a, the nuclear power generation 102b, and the hydroelectric power generation 102c, but also the household electric generator 104 (solar power generation, wind power generation). Therefore, even in the case of fluctuation in power generated from the household electric generator 104, control can be achieved such as the constant amount of power delivered to the outside or discharge conducted as necessary. For example, electric power can be also used in such a way that electric power obtained from solar power generation is stored in the electric storage device 103, and late-night electric power at a lower power rate is stored in the electric storage device 103 during the night, whereas the electric power stored by the electric storage device 103 is discharged and used during hours at a higher power rate in the daytime.

It is to be noted that while a case of the controller 110 housed in the electric storage device 103 has been described in this example, the controller may be housed in the smart meter 107, or configured independently. Furthermore, the electric storage system 100 may be used for more than one home in a housing complex, or used for more than one house.

### 5. Fifth Embodiment

In the third embodiment, an electric vehicle will be described which includes the secondary battery according to the first or second embodiment.

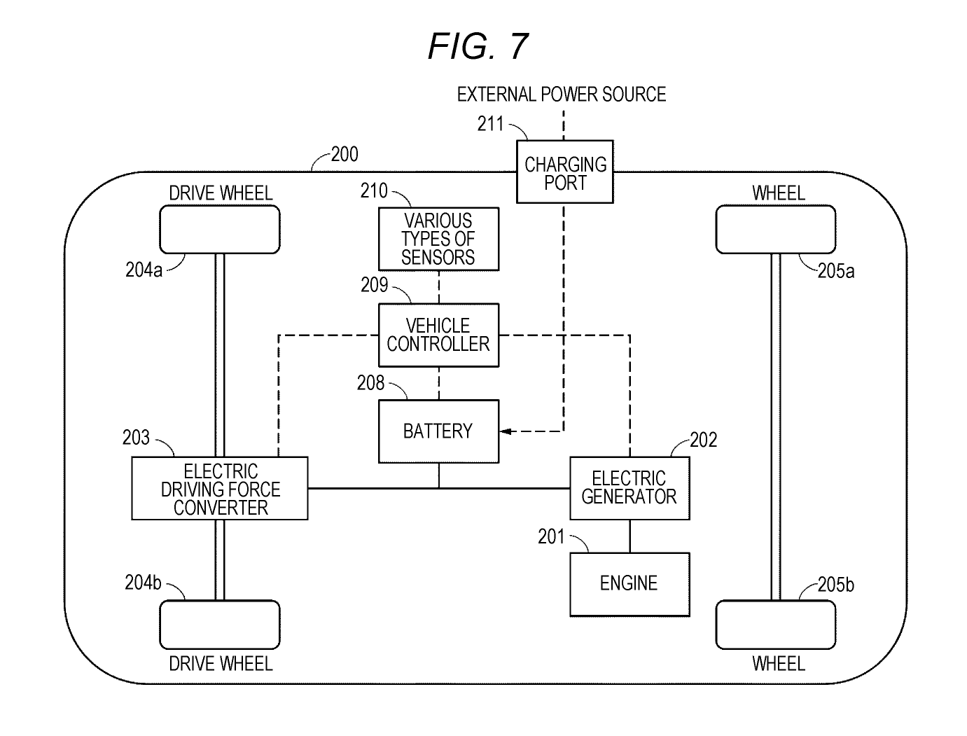

A configuration of an electric vehicle according to a fifth embodiment of the present application will be described with reference to FIG. 7. This hybrid vehicle 200 is a hybrid vehicle which adopts a series hybrid system. The series hybrid system refers to a car running by an electric driving force converter 203 with the use of electric power generated by an electric generator powered by an engine, or the electric power stored once in a battery.

This hybrid vehicle 200 is equipped with an engine 201, an electric generator 202, the electric driving force converter 203, a drive wheel 204a, a drive wheel 204b, a wheel 205a, a wheel 205b, a battery 208, a vehicle controller 209, various types of sensors 210, and a charging port 211. The secondary battery according to the first or second embodiment is used as the battery 208.

The hybrid vehicle 200 runs with the electric driving force converter 203 as a source of power. An example of the electric driving force converter 203 is a motor. The electric driving force converter 203 is operated by electric power from the battery 208, and the torque of the electric driving force converter 203 is transmitted to the drive wheels 204a, 204b. It is to be noted that the electric driving force converter 203 is applicable even in the case of an alternating-current motor or a direct-current motor by use of direct-current to alternating-current (DC-AC) conversion or reverse conversion (AC-DC conversion) at a necessary point. The various types of sensors 210 controls the rotation speed of the engine via the vehicle controller 209, or controls the position of a throttle valve (throttle position), not shown. The various types of sensors 210 include speed sensors, acceleration sensors, and engine speed sensors.

The torque of the engine 201 is transmitted to the electric generator 202, and the torque is able to store, in the battery 208, electric power generated by the electric generator 202.

When the hybrid vehicle 200 is decelerated through a damping mechanism, not shown, the resistance during the deceleration is added as a torque to the electric driving force converter 203, and due to this torque, regenerated electric power generated by the electric driving force converter 203 is stored in the battery 208.

The battery 208 is also able to be connected to a power source external to the hybrid vehicle 200 via the charging port 211, thereby supplied with electric power from the external power source with the charging port 211 as an input port, and store the supplied electric power.

Although not shown, an information processor may be provided which conducts information processing for vehicle control on the basis of information regarding the secondary battery. Such information processors include an information processor which displays the remaining battery level on the basis of information regarding the remaining battery level.

It is to be noted that the hybrid car running by a motor with the use of electric power generated by an electric generator powered by an engine, or the electric power stored once in a battery has been described above as an example. However, the present application is also effectively applicable to parallel hybrid vehicles use the outputs from both an engine and a motor as driving sources, and switch appropriately among three systems of: running by only the engine; running by only the motor; and running by the engine and the motor. Moreover, the present application is also effectively applicable to so-called electric vehicles running by being driven with only driving motors, without using any engines.

### EXAMPLES

The present application will be specifically described below with reference to examples, but is not to be considered limited to only the examples.

Table 1 shows the compositions of positive electrodes A to C.

TABLE 1

| | Active Material | | Conducting Aid | | Binder | |
|---|---|---|---|---|---|---|
| | | Content | | Content | | Content |
| | Type | [mass %] | Type | [mass %] | Type | [mass %] |
| Positive | Insoluble | 60 | VGCF | 30 | Polythiophene | 10 |
| Electrode A | Sulfur | | | | Conductive | |
| Positive | | | MWCNT | 30 | Polymer | |
| Electrode B | | | | | | |
| Positive | | | Porous | 30 | PVA | 10 |
| Electrode C | | | Carbon | | | |
| | | | (KB-600JD) | | | |

VGCF: Vapor Growth Carbon Fiber
MWCNT: Multi Wall Carbon Nanotube

Table 2 shows the compositions of lithium sulfur batteries according to Examples 1 to 6 and Comparative Examples 1 to 3.

TABLE 2

| | Positive | Conductive | | Negative |
|---|---|---|---|---|
| | Electrode | Interlayer | Electrolyte | Electrode |
| Example 1 | Positive | Carbon Felt | Electrolytic | Li |
| | Electrode A | | Solution A | |
| Example 2 | Positive | Carbon Felt | Electrolytic | Li |
| | Electrode B | | Solution A | |
| Example 3 | Positive | SUS Mesh (200) | Electrolytic | Li |
| | Electrode A | | Solution A | |
| Example 4 | Positive | SUS Mesh (300) | Electrolytic | Li |
| | Electrode A | | Solution A | |
| Example 5 | Positive | SUS Mesh (400) | Electrolytic | Li |
| | Electrode A | | Solution A | |
| Example 6 | Positive | MWCNT Layer | Electrolytic | Li |
| | Electrode A | | Solution A | |
| Comparative | Positive | No | Electrolytic | Li |
| Example 1 | Electrode A | | Solution A | |
| Comparative | Positive | No | Electrolytic | Li |
| Example 2 | Electrode A | | Solution B | |
| Comparative | Positive | No | Electrolytic | Li |
| Example 3 | Electrode C | | Solution A | |
| Comparative | Positive | No | Electrolytic | Li |
| Example 4 | Electrode C | | Solution B | |

Electrolytic Solution A: 0.5M LiTFSI + 0.4M LiNO₃ DME/DOL (1/1 = w/w)
Electrolytic Solution B: tetraglyme/LiTFSI/1,1,2,2-tetrafluoroethyl-2, 2,3,3-tetrafluoropropyl ether (1/1/1 = mol/mol/mol)

Examples according to the present application will be described in the following order.

i. Preparation Process for Positive Electrode

ii. Preparation Process for Battery

iii. Evaluation of Charge-Discharge Characteristics and Cycle Characteristics (Conductive Interlayer: Carbon Felt)

iv. Evaluation of Impedance Spectrum (Conductive Interlayer: Carbon Felt)

v. Confirmation of Li₂Sₓ Constituent (Conductive Interlayer: Carbon Felt)

vi. Evaluation of Cycle Characteristics (Conductive Interlayer: SUS Mesh, MWCNT Layer)

vii. Evaluation of Rate Characteristics (Conductive Interlayer: Carbon Felt, SUS Mesh, MWCNT Layer)

<i. Preparation Process for Positive Electrode>

(Positive Electrode A)

First, insoluble sulfur as a positive electrode active material: 60 mass %, VGCF as a conducting aid: 30 percent by mass, and a polythiophene conductive polymer as a binder: 10 mass % were kneaded with N-methyl-2-pyrrolidone (NMP) to prepare positive electrode combination slurry. Next, the prepared positive electrode combination slurry was applied onto aluminum foil (positive electrode collector) of 20 μm in thickness, and dried to form a positive electrode active material layer on the aluminum foil, thereby providing a positive electrode. Next, this positive electrode was subjected to punching into a circular shape of 15 mm in diameter, and then compressed with a pressing machine. Thus, obtained was the positive electrode A including the positive electrode active material layer of 10 μm to 20 μm in thickness.

(Positive Electrode B)

Except for the addition of MWCNT in place of VGCF in the step of preparing the positive electrode combination, the positive electrode B was obtained in the same way as the positive electrode A.

(Positive Electrode C)

Except for the use of granular porous carbon (Ketjen Black KB-600JD from Lion Corporation) as a conducting aid and polyvinyl alcohol (PVA) as a binder in the step of preparing the positive electrode combination, the positive electrode C was obtained in the same way as the positive electrode A.

<ii. Preparation Process for Battery>

### Example 1

The positive electrode A mentioned above was used to prepare a coin-type lithium sulfur battery (hereinafter, appropriately referred to as a “a coin cell”) of size 2016 (size of 20 mm in diameter and 1.6 mm in height) in the following way. First, a circular separator (20BMU from Tonen Corporation) of 19 mm in diameter and 20 μm in thickness was placed on a circular lithium metal (negative electrode) of 15.5 mm in diameter and 800 μm in thickness, and a 40 μL electrolytic solution was then delivered by drops onto the separator. It is to be noted that as the electrolytic solution, 0.5 M lithium bis(trifluoromethanesulfonyl)imide (LiTFSI) and 0.4 M lithium nitrate (LiNO₃) were used which were dissolved in a mixed solvent of 1,2-dimethoxyethane (DME) and 1,3-dioxolan (DOL) mixed at 1:1 in mass ratio.

Next, the conductive interlayer was placed on the separator, 60 μL of the electrolytic solution was then further delivered by drops, and the positive electrode was then placed on the conductive interlayer. It is to be noted that as the conductive interlayer, carbon felt of 250 μm in thickness (TCC-3250 from Toho Tenax Co., Ltd.) was subjected to punching into a circular shape of 15 mm in diameter, and used. Next, the stacked body obtained in the way described above was housed within an exterior cup and an exterior can, and peripheral parts of the exterior cup and exterior can were then swaged with a gasket interposed. Thus, the targeted coin cell was obtained.

### Example 2

Except for the use of the positive electrode B in place of the positive electrode A, a coin cell was obtained in the same way as in Example 1.

### Example 3

Except for the use of a SUS mesh (Mesh Number (inch): 200) as the conductive interlayer in place of the carbon felt, a coin cell was obtained in the same way as in Example 1.

### Example 4

Except for the use of a SUS mesh (Mesh Number (inch): 300) as the conductive interlayer in place of the carbon felt, a coin cell was obtained in the same way as in Example 1.

### Example 5

Except for the use of a SUS mesh (Mesh Number (inch): 400) as the conductive interlayer in place of the carbon felt, a coin cell was obtained in the same way as in Example 1.

### Example 6

Except for the use of a MWCNT layer as the conductive interlayer in place of the carbon felt, a coin cell was obtained in the same way as in Example 1.

It is to be noted that a layer prepared in the following way was used as the MWCNT layer. First, MWCNT as carbon fibers: 10 mass % was dispersed in N-methyl-2-pyrrolidone (NMP) as a solvent to prepare a composition for the formation of the MWCNT layer. Next, the prepared composition was applied onto a flat plate, dried, and then peeled to prepare the MWCNT layer.

### Comparative Example 1

Except that the conductive interlayer was omitted to place the positive electrode directly on the separator, a coin cell was obtained in the same way as in Example 1.

### Comparative Example 2

Except for the use of, as the electrolytic solution, tetraglyme, LiTFSI, and 1,1,2,2-tetrafluoroethyl-2,2,3,3-tetrafluoropropylether mixed at 1:1:1 in molar ratio, a coin cell was obtained in the same way as in Comparative Example 1.

### Comparative Example 3

The positive electrode C was used in place of the positive electrode A. In addition, the conductive interlayer was omitted to place the positive electrode C directly on the separator. Except for the foregoing, a coin cell was obtained in the same way as in Example 1.

### Comparative Example 4

Except for the use of, as the electrolyte, tetraglyme, LiTFSI, and 1,1,2,2-tetrafluoroethyl-2,2,3,3-tetrafluoropropylether mixed at 1:1:1 in molar ratio, a coin cell was obtained in the same way as in Comparative Example 3.

<iii. Evaluation of Charge-Discharge Characteristics and Cycle Characteristics (Conductive Interlayer: Carbon Felt)>

The coin cells according to Examples 1 and 2 and Comparative Example 1, which were prepared in the way described above were subjected to a charge-discharge test under the following condition to examine the charge-discharge characteristics and cycle characteristics of the coin cells.

Discharge: CC (Constant Current) Mode

Charge: CC/CV (Constant Current/Constant Voltage) Mode

Cutoff Voltage: 1.5 V (Discharge), 3.3 V (Charge)

Charge-Discharge Rate (Current Density): sequence control of changing the charge-discharge rate (current density) in the following order

2 cycles: 0.0319 C (0.05 mA/cm²)

5 cycles: 0.0638 C (0.1 mA/cm²)

5 cycles: 0.128 C (0.2 mA/cm²)

5 cycles: 0.256 C (0.4 mA/cm²)

5 cycles: 0.512 C (0.8 mA/cm²)

5 cycles: 1.28 C (2 mA/cm²)

5 cycles: 3.84 C (6 mA/cm²)

3 cycles: 1.28 C (2 mA/cm²)

It is to be noted that the term “1 C” refers to a current value at which the rating capacity of the battery is discharged with the constant current for 1 hour. Therefore, for example, the term “0.319 C” refers to a current value at which the rating capacity of the battery is discharged for 187.8 minutes (3.13 hours), and the term “1.28 C” refers to a current value at which the rating capacity of the battery is discharged for 46.8 minutes (0.78 hours).

[Evaluation Result of Example 1]

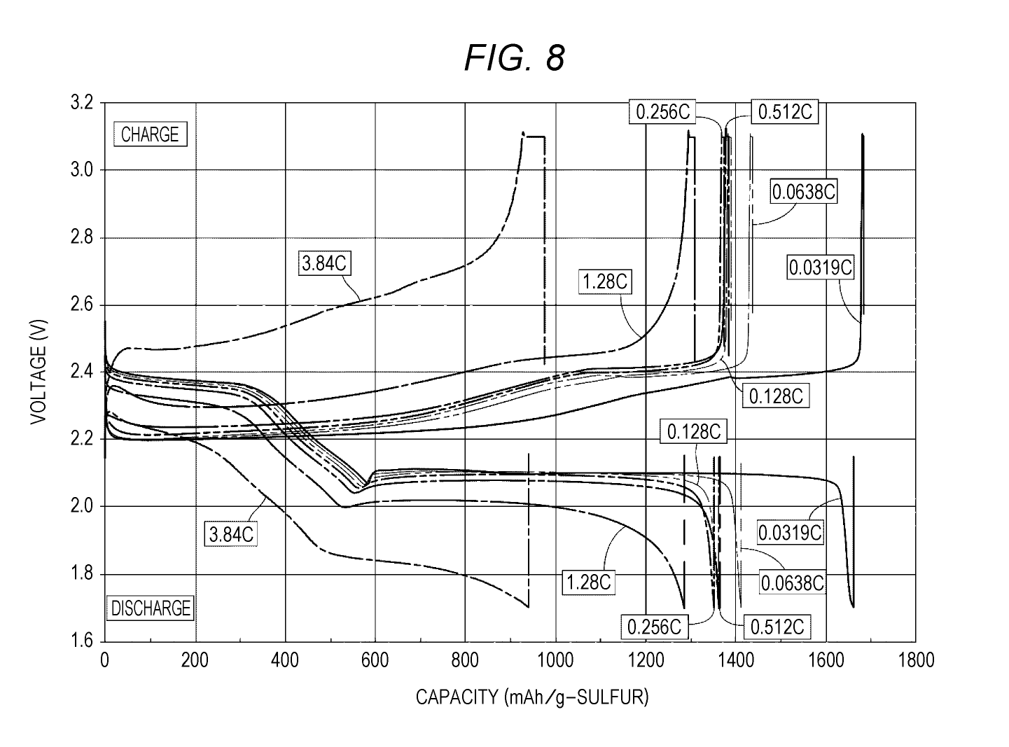

FIG. 8 shows the charge-discharge characteristics of the lithium sulfur battery according to Example 1. The following is determined from FIG. 8. At the charge-discharge rate of 0.0319 C (0.05 mA/cm²), a discharge curve is achieved which represents nearly the theoretical capacity. Furthermore, a plateau in the end of the charge is confirmed which has the same potential and capacity as those of the first plateau in the discharge. This plateau is a result that has not been found before in evaluations on various materials or even literature reports. In addition, even when the charge-discharge rate is increased up to 0.256 C (0.4 mA/cm²), the capacity shows approximately 1400 mAh/g-s. In the case of previous lithium sulfur batteries, the capacity maintenance ratio is rapidly decreased dramatically on reaching 0.1 C, whereas such a decrease is not observed in the case of the lithium sulfur battery according to Example 1, which exhibits favorable rate characteristics. Referring to the charge-discharge curve more specifically, while there is a tendency to decrease the first plateau potential and the discharge capacity when the charge-discharge rate reaches a high rate of 0.1 C or more in the case of previous lithium sulfur batteries, it is surprising that the first plateau voltage drop and the capacity drop are both hardly observed even at a high rate of 0.1 C or more in the case of the lithium sulfur battery according to Example 1.

Furthermore, the discharge capacity of approximately 1000 mAh/g-s was exhibited even at the charge-discharge rate of 3.84 C (6 mA/cm²). More specifically, although the capacity maintenance ratio has not come up to those of existing lithium ion secondary batteries which use LCO (LiCoO₂: lithium cobalt oxide) for positive electrodes, lithium sulfur batteries can be achieved which exhibit top-class rate characteristics among previously reported lithium sulfur batteries.

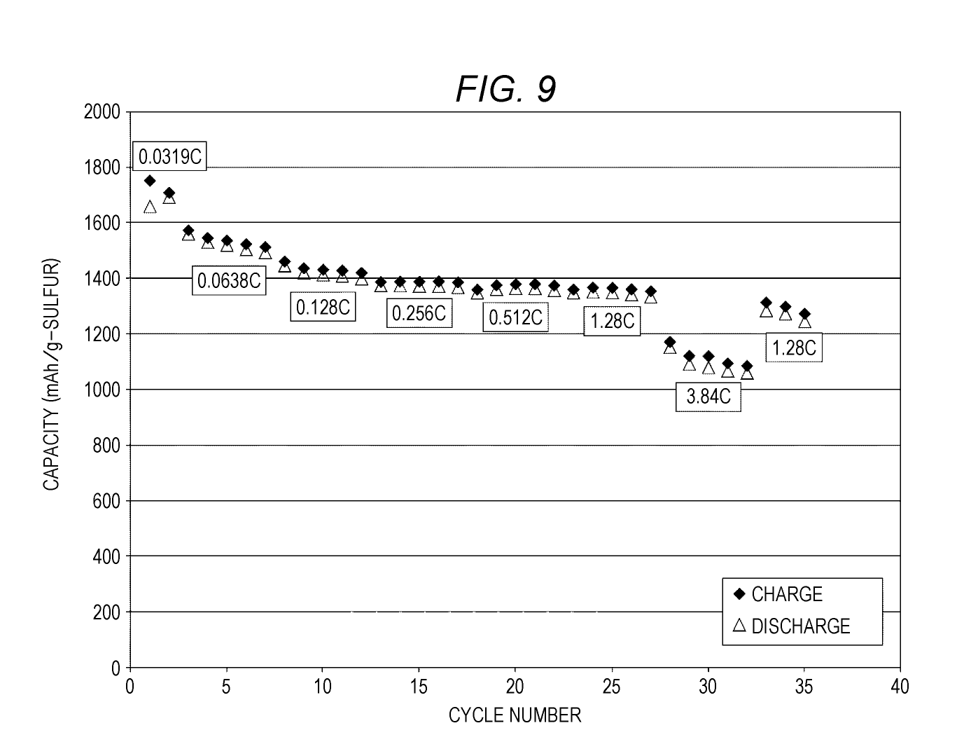

FIG. 9 shows cycle characteristics of the lithium sulfur battery according to Example 1. The following is determined from FIG. 9. Although there is a tendency to somewhat decrease the charge/discharge rate when the charge-discharge rate reaches an extremely high rate of 3.84 C, favorable discharge capacities have been achieved even after 30 cycles. Therefore, excellent cycle characteristics can be achieved even after the 30 cycles. In addition, the charge capacity is nearly equal to the discharge capacity in the rate range of 0.0319 C to 3.48 C. Accordingly, a favorable coulombic efficiency can be achieved.

[Evaluation Result of Example 2]

In the case of the use of the positive electrode B in place of the positive electrode A (that is, in the case of use of MWCNT in place of VGCF as the conducing aid for the positive electrode), almost the same results have been achieved as in the case of the use of the positive electrode A (that is, in the case of the use of VGCF as the conducting aid for the positive electrode), except for a slight decrease observed in charge/discharge capacity.

[Evaluation Result of Comparative Example 1]

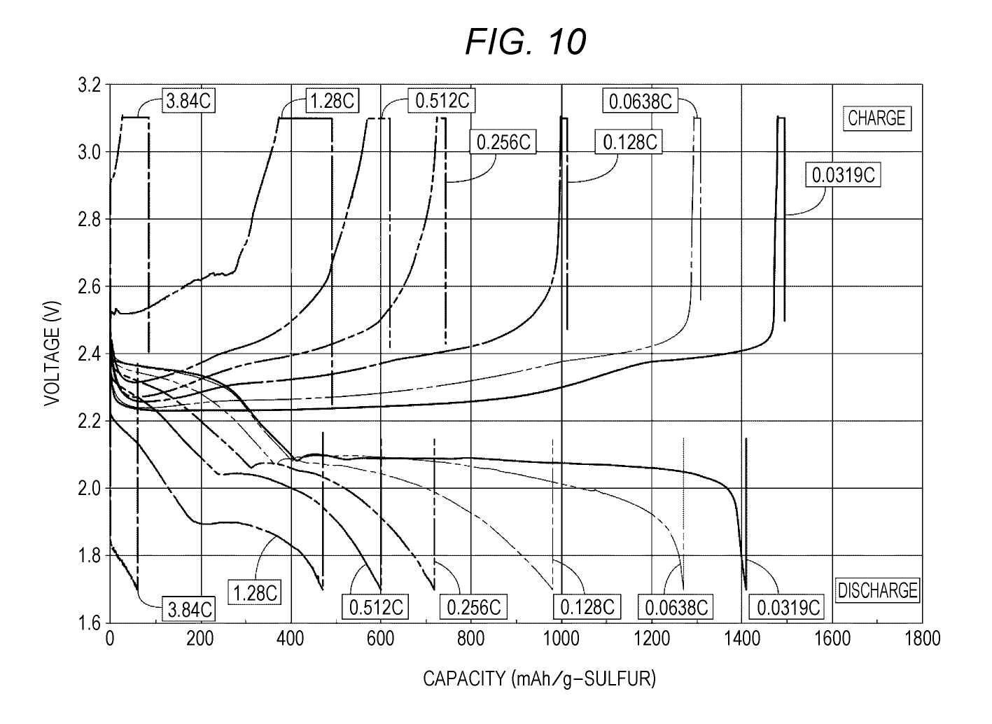

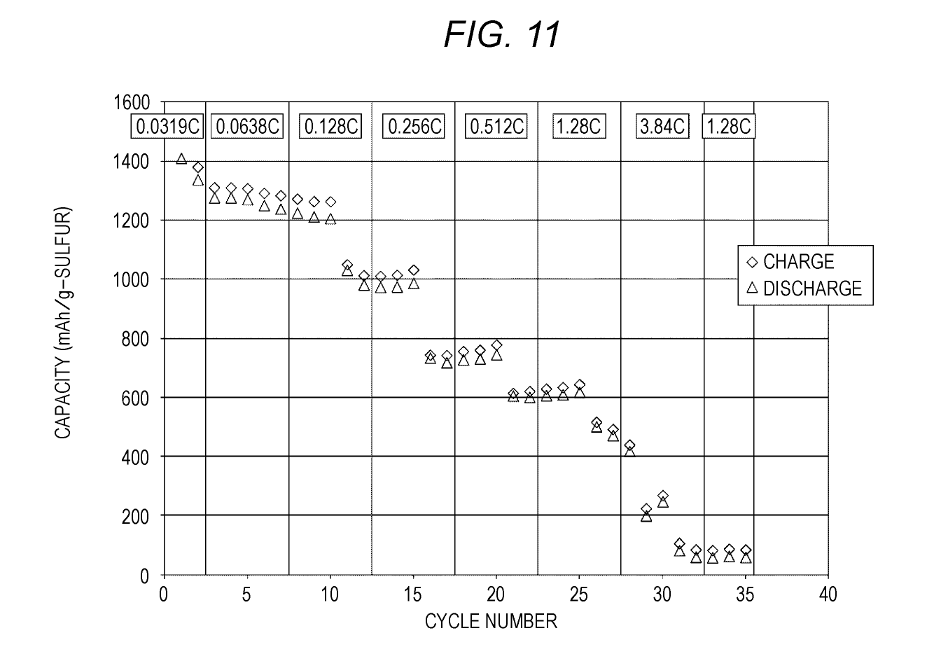

FIG. 10 shows charge-discharge characteristics of the coin cell according to Comparative Example 1. FIG. 11 shows cycle characteristics of the coin cell according to Comparative Example 1. From FIGS. 10 and 11, it is determined that the discharge capacity is significantly decreased in Comparative Example 1 as compared with Example 1. In addition, it is determined that the discharge capacity is significantly decreased with the decrease in charge-discharge rate in Comparative Example 1.

From the evaluation results, the carbon felt as the conductive interlayer provided between the positive electrode and the separator can increase the positive electrode utilization, and further improve the rate characteristics.

<iv. Evaluation of Impedance Spectrum (Conductive Interlayer: Carbon Felt)>

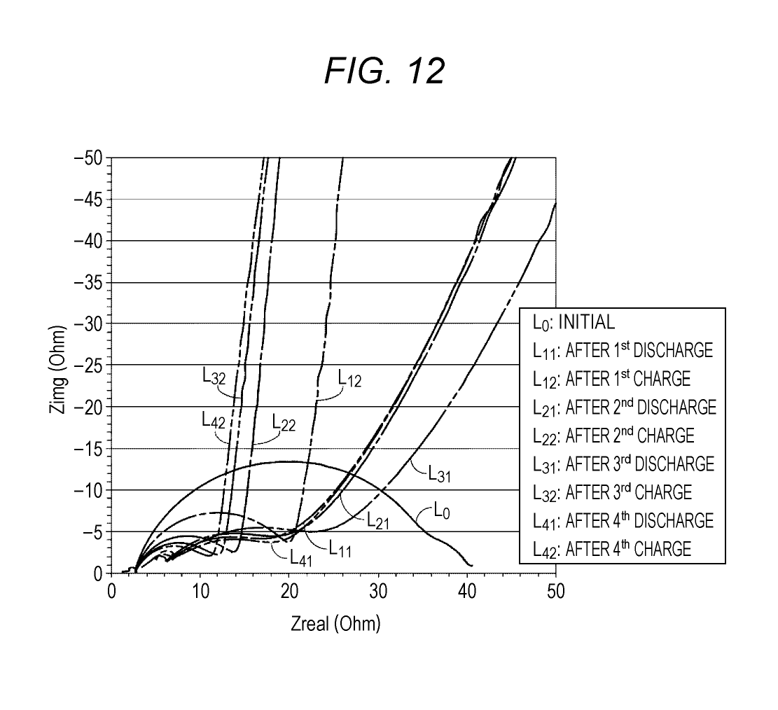

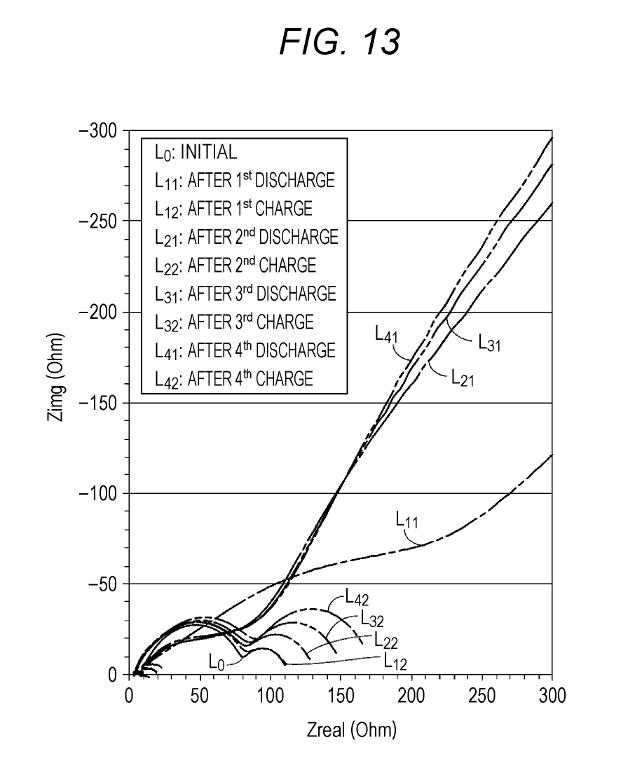

The lithium sulfur batteries prepared in the way described above according to Example 1 and Comparative Example 1 were subjected to impedance measurement around 4 cycles of charge and discharge (charge-discharge rate (current density): 0.0319 C (50 μA/cm²)). The impedance spectra acquired as a result thereof are shown in FIG. 12 (Example 1) and FIG. 13 (Comparative Example 1). It is to be noted that an electrochemical measurement device (VMP-3 from BioLogic) was used for the impedance test.

The following is determined from FIGS. 12 and 13. In the case of Comparative Example 1 without using any carbon felt, an interface resistance was observed between the two interfaces of the positive electrode and negative electrode before the start of the test, and when discharge was carried out, a large collapsed circular arc was observed. This is believed to be because sulfur or lithium sulfide is dissolved in the electrolytic solution to lose any electron conduction path, furthermore, Li₂S as a non-conductor is deposited, e.g., on the surface of the conducting aid in the positive electrode as an electron conduction path with a volume expansion, and the resistance value is increased with repeated cycles. On the other hand, in the case of Example 1 using the carbon felt, no increase in resistance was observed even when the charge-discharge cycle was repeated, also with the low interface resistance before the start of the test. This is believed to be because the state of low resistance is maintained even when Li₂S is deposited, due to sufficient spaces and conductivity ensured.

<v. Confirmation of Li₂Sₓ Constituent (Conductive Interlayer: Carbon Felt)>

The lithium sulfur batteries according to Example 1 and Comparative Example 1 after the impedance test (4 cycles of charge and discharge) were dismantled to visually confirm the Li₂Sₓ constituent. As a result, in the case of Comparative Example 1 without using any carbon felt, a red-drown Li₂Sₓ constituent was able to be confirmed even around the negative electrode, and the migration of Li₂Sₓ was confirmed even around the negative electrode. On the other hand, in the case of Example 1 using the carbon felt, no red-drown Li₂Sₓ constituent was visually confirmed on the negative electrode side, but the Li metal was glossy at the surface thereof. Therefore, it can be confirmed that Li₂Sₓ dissolved and migrating from the positive electrode can be trapped by the carbon felt.

<vi. Evaluation of Cycle Characteristics (Conductive Interlayer: SUS Mesh, MWCNT Layer)>

The coin cells according to Examples 3 to 6, which were prepared in the way described above were subjected to a charge-discharge test under the following condition to examine the cycle characteristics of the coin cells.

Discharge: CC (Constant Current) Mode

Charge: CC/CV (Constant Current/Constant Voltage) Mode

Cutoff Voltage: 1.5 V (Discharge), 3.3 V (Charge)

Charge-Discharge Rate: sequence control of changing the charge-discharge rate in the following order

2 cycles: 0.03 C

5 cycles: 0.06 C

5 cycles: 0.12 C

5 cycles: 0.24 C

5 cycles: 0.48 C

5 cycles: 1.2 C

5 cycles: 3.8 C

5 cycles: 1.2 C

5 cycles: 0.24 C

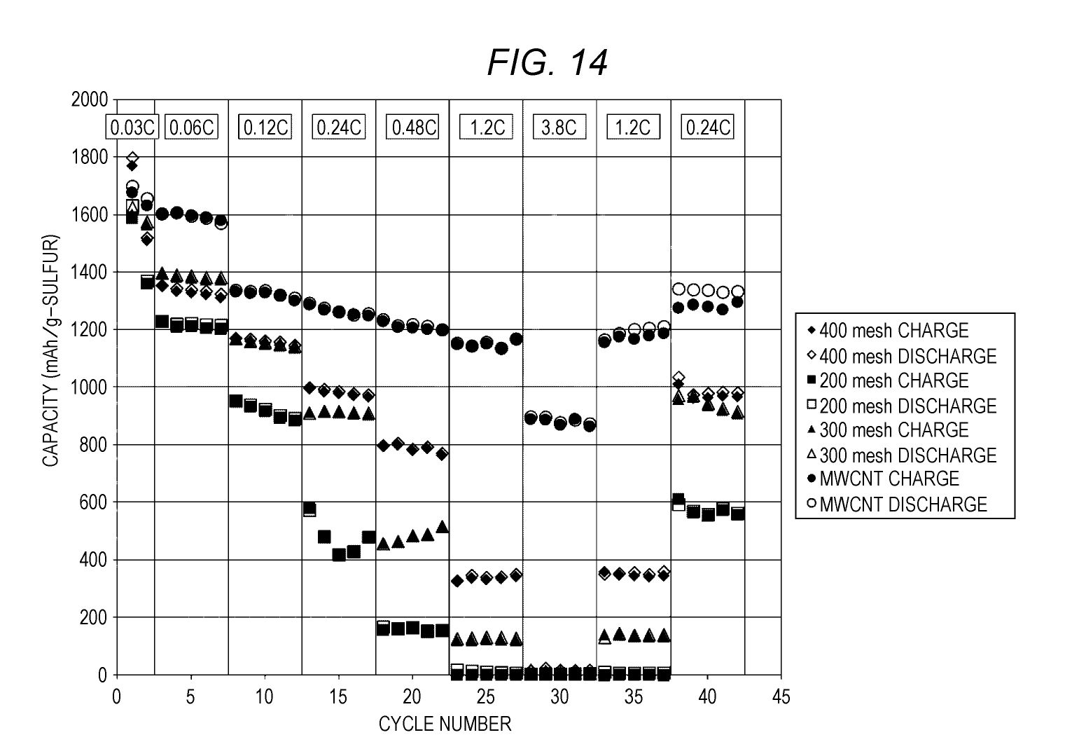

FIG. 14 shows cycle characteristics of the lithium sulfur batteries according to Examples 3 to 6. The following is determined from FIG. 14. Example 6 which uses the MWCNT layer as the conductive interlayer can improve the cycle characteristics, as compared with Examples 3 to 5 which use the metal meshes as the conductive interlayer.

When FIG. 9 is compared with FIG. 14, it is determined that Example 6 which uses the MWCNT layer as the conductive interlayer shows almost the same tendency as that of Example 1 which uses the carbon felt as the conductive interlayer.

<vii. Evaluation of Rate Characteristics (Conductive Interlayer: Carbon Felt, SUS Mesh, MWCNT Layer)>

The coin cells according to Examples 1 to 6 and Comparative Examples 1 to 4, which were prepared in the way described above were subjected to a charge-discharge test under the following condition to examine the rate characteristics of the coin cells.

Discharge: CC (Constant Current) Mode

Charge: CC/CV (Constant Current/Constant Voltage) Mode

Cutoff Voltage: 1.5 V (Discharge), 3.3 V (Charge)

Charge-Discharge Rate: charge-discharge rate changed in the range of 0.05 C to 3.84 C

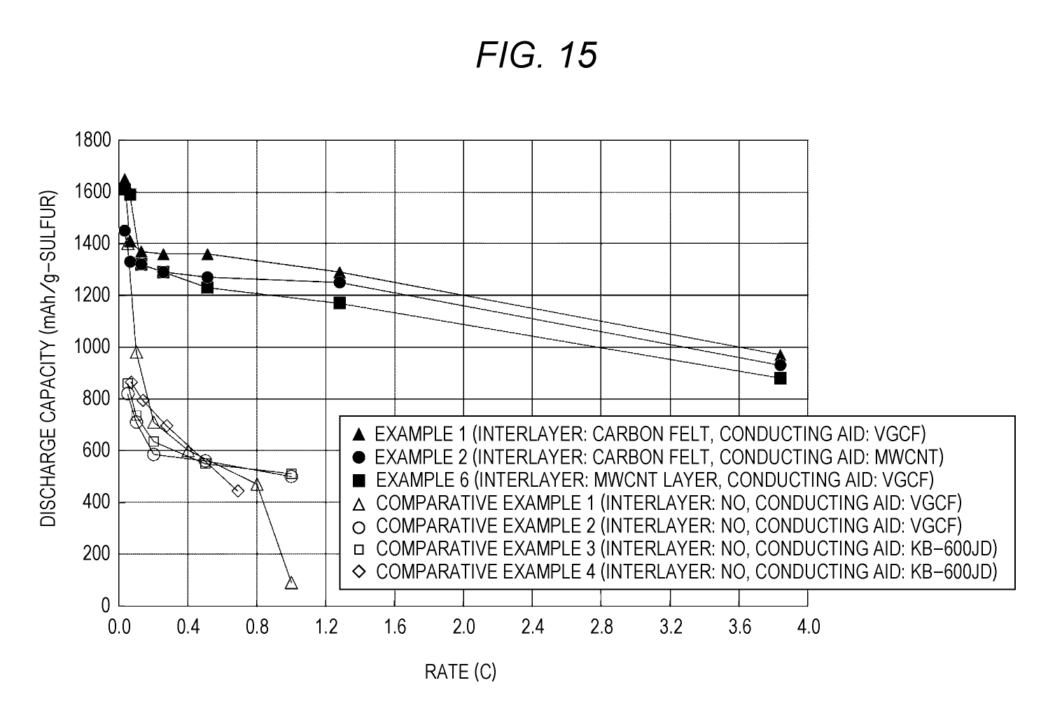

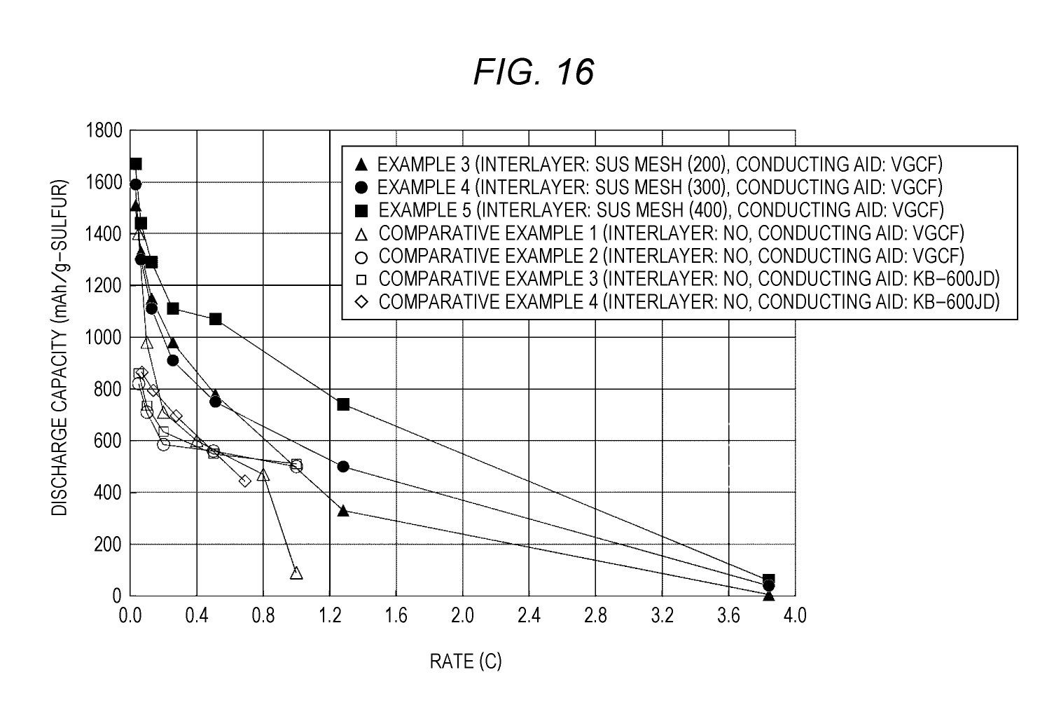

FIG. 15 shows rate characteristics of the coil cells according to Examples 1, 2, and 6 and Comparative Examples 1 to 4. FIG. 16 shows rate characteristics of the coin cells according to Examples 3 to 5 and Comparative Examples 1 to 4. The following is determined from FIGS. 15 and 16. Examples 1 to 6 which uses the conductive interlayers have rate characteristics improved as compared with Comparative Examples 1 to 4 which use no conductive interlayers. In particular, Examples 1, 2, and 6 which use the carbon felt and the MWCNT layer as the conductive interlayer achieve excellent rate characteristics.

When the non-amorphous carbon is used as the conducting aid for the positive electrode, a high discharge capacity can be achieved as compared with when the porous carbon is used as the conducting aid for the positive electrode. This is believed to be because the use of the non-porous carbon as the conducting aid for the positive electrode causes Li₂Sₓ dissolved in the electrolytic solution to migrate into the carbon felt without being held in the porous carbon, thereby making the positive electrode reaction to proceed.

In addition, while the Li₂Sₓ causes a volume expansion as the discharge reaction proceeds, the carbon felt ensures therein spaces for the volume expansion and electron conduction paths. Therefore, the positive electrode reaction is believed to proceed more advantageously in the carbon felt than in the porous carbon (conducting aid).

While the embodiments and modification examples thereof according to the present application have been specifically described above, the present application is not to be considered limited to the embodiments and modification examples thereof described above, but various modifications can be made which are based on the technical idea of the present application.

For example, the compositions, methods, steps, shapes, materials, and numerical values cited in the embodiments and modification examples thereof described above are absolutely considered by way of example only, and compositions, methods, steps, shapes, materials, and numerical values which are different from the foregoing may be used, if necessary.

In addition, the compositions, methods, steps, shapes, materials, and numerical values, etc. in the embodiments and modification examples thereof described above can be combined with each other, without departing from the scope of the present application.

Furthermore, while examples of applying the present application to batteries which have rolled structure have been described in the embodiments and modification examples thereof described above, the battery structure is not to be considered limited to these examples, but the present application is also applicable to, e.g., batteries structured to have a positive electrode and a negative electrode folded or stacked.

Furthermore, while examples of applying the present application to cylindrical or flattened batteries have been described in the embodiments and modification examples thereof described above, the battery shape is not to be considered limited to these examples, but the present application is also applicable to batteries such as a coin type, a button type, or an angular type.

In addition, the positive electrode configured to have the positive electrode collector and the positive electrode active material layer has been described as an example in the embodiments and modification examples thereof described above, the configuration of the positive electrode is not to be considered limited to this example. For example, the positive electrode may be configured to have only the positive electrode active material layer.

Furthermore, the present application can also adopt the following configurations.
(1) A battery including:
a positive electrode containing sulfur;
a negative electrode containing lithium;
an electrolyte; and
a conductive interlayer provided between the positive electrode and the negative electrode,
where the conductive interlayer includes a conductive fiber-containing layer, a conductive nanotube-containing layer, or a conductive mesh.
(2) The battery according to (1), where the conductive fiber-containing layer includes a conductive non-woven fabric or a conductive woven fabric.
(3) The battery according to (1) or (2), where the conductive fiber contains at least one selected from the group consisting of carbon, metals, and conductive polymers.
(4) The battery according to (1), where the conductive nanotube is a carbon nanotube.
(5) The battery according to (1), where the conductive mesh contains a metal.
(6) The battery according to any one of (1) to (5), where the positive electrode contains a non-porous conducting aid.
(7) The battery according to (6), where the conducting aid contains at least one selected from the group consisting of carbon fibers and carbon nanotubes.
(8) The battery according to any one of (1) to (7), where the electrolyte contains a kasolite electrolytic solution.
(9) The battery according to any one of (1) to (8), where the conductive interlayer has a space for accepting a volume expansion of lithium sulfide.
(10) The battery according to any one of (1) to (9), where the conductive interlayer holds the electrolyte, achieves lithium ion permeation, and gives and receives electrons to and from sulfur or lithium sulfide dissolved in the electrolyte.
(11) A battery pack including the battery according to any one of (1) to (9).
(12) An electronic device provided with the battery according to any one of (1) to (9), and powered by the battery.
(13) An electric vehicle including a battery, a conversion device powered by the battery to convert the power to a driving force for the vehicle, and a controller for conducting information processing for vehicle control on the basis of information regarding the battery, where the battery is the battery according to any one of (1) to (9).
(14) An electric storage device provided with the battery according to any one of (1) to (9), for supplying power to an electronic device connected the battery.
(15) The electric storage device according to (14), the device including a power information controller for transmitting and receiving signals to and from other device via a network, and controlling charge and discharge for the battery on the basis of information received by the power information controller.
(16) An electric power system including the battery according to any one of (1) to (9), where the system is powered by the battery, or electric power is supplied from an electric generator or a power network to the battery.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

### REFERENCE SIGNS LIST

11 battery can
12, 13 insulating plate
14 battery lid
15 safety valve mechanism
15A disk plate
16 heat-sensitive resistive element
17 gasket
20 rolled electrode body
21 positive electrode
21A positive electrode collector
21B positive electrode active material layer
22 negative electrode
23 conductive interlayer
24 separator
25 center pin
26 positive electrode lead
27 negative electrode lead

The invention is claimed as follows:

1. A battery comprising:
a positive electrode containing sulfur;
a negative electrode containing lithium;
an electrolyte; and
a conductive interlayer provided between the positive electrode and the negative electrode,
wherein the conductive interlayer includes a conductive fiber-containing layer, a conductive nanotube-containing layer, or a conductive mesh.

2. The battery according to claim 1, wherein the conductive fiber-containing layer comprises a conductive non-woven fabric or a conductive woven fabric.

3. The battery according to claim 2, wherein the conductive fiber comprises at least one selected from the group consisting of carbon, metals, and conductive polymers.

4. The battery according to claim 1, wherein the conductive nanotube is a carbon nanotube.

5. The battery according to claim 1, wherein the conductive mesh comprises a metal.

6. The battery according to claim 1, wherein the positive electrode comprises a non-porous conducting aid.

7. The battery according to claim 6, wherein the conducting aid comprises at least one selected from the group consisting of carbon fibers and carbon nanotubes.

8. The battery according to claim 1, wherein the electrolyte comprises a kasolite electrolytic solution.

9. The battery according to claim 1, wherein the conductive interlayer has a space that accepts a volume expansion of lithium sulfide.

10. The battery according to claim 1, wherein the conductive interlayer holds the electrolyte, achieves lithium ion permeation, and gives and receives electrons to and from sulfur or lithium sulfide dissolved in the electrolyte.

11. A battery pack comprising a battery including:
a positive electrode containing sulfur;
a negative electrode containing lithium;
an electrolyte; and
a conductive interlayer provided between the positive electrode and the negative electrode,
wherein the conductive interlayer includes a conductive fiber-containing layer, a conductive nanotube-containing layer, or a conductive mesh.

12. An electronic device comprising a battery including:
a positive electrode containing sulfur;
a negative electrode containing lithium;
an electrolyte; and
a conductive interlayer provided between the positive electrode and the negative electrode,
wherein the conductive interlayer includes a conductive fiber-containing layer, a conductive nanotube-containing layer, or a conductive mesh, and
the electronic device is powered by the battery.

13. An electric vehicle comprising:
a battery;
a conversion device powered by the battery to convert the power to a driving force for the vehicle; and
a controller that conducts information processing for vehicle control on the basis of information regarding the battery,
wherein the battery includes:
a positive electrode containing sulfur;
a negative electrode containing lithium;
an electrolyte; and
a conductive interlayer provided between the positive electrode and the negative electrode, and
the conductive interlayer includes a conductive fiber-containing layer, a conductive nanotube-containing layer, or a conductive mesh.

14. An electric storage device comprising a battery including:
a positive electrode containing sulfur;
a negative electrode containing lithium;
an electrolyte; and
a conductive interlayer provided between the positive electrode and the negative electrode,
wherein the conductive interlayer includes a conductive fiber-containing layer, a conductive nanotube-containing layer, or a conductive mesh, to supply electric power to an electronic device connected to the battery.

15. The electric storage device according to claim 14, the device comprising a power information controller that transmits and receives signals to and from other device via a network, and controlling charge and discharge for the battery on the basis of information received by the power information controller.

16. An electric power system comprising a battery including:
a positive electrode containing sulfur;
a negative electrode containing lithium;
an electrolyte; and
a conductive interlayer provided between the positive electrode and the negative electrode,
wherein the conductive interlayer includes a conductive fiber-containing layer, a conductive nanotube-containing layer, or a conductive mesh, and
the system is powered by the battery, or electric power is supplied from an electric generator or a power network to the battery.
